(19) United States
(12) Patent Application Publication
(10) Pub. No.: US 2024/0401657 A1
(43) Pub. Date: Dec. 5, 2024

(54) Brake Application Device of a Disc Brake for a Commercial Vehicle

(71) Applicant: KNORR-BREMSE Systeme fuer Nutzfahrzeuge GmbH, Muenchen (DE)

(72) Inventors: Michael HIDRINGER, Winzer (DE); Andreas PETSCHKE, Neuburg am Inn (DE); Thomas BECK, Neukirchen vorm Wald (DE)

(21) Appl. No.: 18/700,769

(22) PCT Filed: Oct. 11, 2022
(86) PCT No.: PCT/EP2022/078301

§ 371 Date: Apr. 12, 2024

(30) Foreign Application Priority Data
Oct. 15, 2021 (DE) 10 2021 126 766.8

(51) Int. Cl. F16D 65/18; F16D 65/56; F16D 121/04

(52) U.S. Cl. CPC F16D 65/183; F16D 65/568; F16D 2121/04

(57) ABSTRACT

A brake application device of a disc brake for a commercial vehicle has a brake lever that acts on a brake plunger, wherein the brake plunger has an adjusting spindle provided with an external thread and a pressure piece, which bears against a radially aligned support surface of the adjusting spindle facing a brake pad. The outer diameter of the support surface is at least 60% of the diameter of the pressure surface of the pressure piece.

### BACKGROUND AND SUMMARY

The invention relates to a brake application device of a disc brake for a commercial vehicle.

The brake application device of a disc brake is arranged in a brake caliper that straddles a brake disc on the vehicle, whereby a brake plunger is held in a bridge that can be moved in the direction of the brake disc by means of a pivoting brake lever, which can be actuated pneumatically or electromechanically, during braking, taking the brake plunger with it.

A pressure piece of the brake plunger comes into contact with an associated brake pad, which is pressed against the brake disc.

The thrust piece rests on a frontal support surface of the adjusting spindle and is held rotatably relative to it, for which purpose a concentric pin of the adjusting spindle is inserted into a blind bore of the thrust piece. A sliding ring is arranged between the pin and the blind bore of the thrust piece, which enables the thrust piece to rotate smoothly when an adjustment device is used to compensate for a wear-related change in a clearance, i.e. the distance between the brake pad and the brake disc.

Here, the adjusting spindle is rotated for an axial stroke while the thrust piece remains in the position it has assumed. The pressure piece is usually secured against rotation in relation to the adjusting spindle by means of a bellows, which seals the brake caliper's mounting space, which accommodates the brake application device, against the environment.

To secure the thrust piece axially on the adjusting spindle, the thrust piece is caulked on the pivot of the adjusting spindle or by a shoulder in this area.

The outer diameter of the support surface of the adjusting spindle corresponds to the nominal diameter of the external thread of the adjusting spindle in the known brake plunger, as known for example from DE 10 2015 110 231 A1, or is smaller than the nominal diameter, while the outer diameter of the thrust piece is significantly larger.

However, this results in problems in the function of the brake application device, i.e. when the thrust piece is in contact with the brake pad in the event of braking, in that the thrust piece tilts due to the forces exerted by the incoming brake disc and its lever arms to support the brake pad, as well as due to caliper deformations, resulting in diagonal wear of the brake pad. This is particularly the case with a single-piston design of the brake application device.

The service life of the disc brake is reduced to an unacceptable level, mainly due to the increased wear of the brake pad, as this means premature repair work.

These, in turn, lead to a corresponding increase in operating costs, which result, on the one hand, from the procurement of spare parts and assembly costs and, on the other hand, from the downtimes of the vehicle, whose disc brakes have to be processed accordingly.

The invention is based on the task of further developing a brake application device of the generic type in such a way that the service life of the disc brake is increased overall and thus the operating costs are reduced.

This task is solved by a brake application device with the features of the independent claims.

This design of the brake plunger or the adjusting spindle creates a larger support surface, which reduces the tilting moment resulting from braking and thus counteracts the aforementioned diagonal wear.

It should also be noted that the invention can be realized with little manufacturing effort.

Further advantageous embodiments of the invention are characterized in the dependent claims.

In terms of design, there are various options for designing the brake plunger in accordance with the invention.

Thus, as before, the supporting surface of the adjusting spindle can be dimensioned accordingly when shaping it, i.e. the end face of the adjusting spindle assigned to the thrust piece is dimensioned with respect to its diameter in accordance with the invention.

However, it is also contemplated to increase the support surface by means of a separate part, for example in the form of a ring which is placed on the corresponding end of the adjusting spindle and whose surface facing the pressure piece, in combination with the front surface of the adjusting spindle, results in the enlarged support surface.

Alternatively, the ring can also be designed in such a way that it also covers the end face of the adjusting spindle, whereby in any case the pin of the adjusting spindle carrying the thrust piece passes through the ring. If the ring also covers the end face of the adjusting spindle, the support surface is uninterrupted, with the exception of a central opening for the pin to pass through.

The use of a ring in both forms described also allows the support surface to be subsequently enlarged in the case of an already mounted brake application device, since the adjusting spindle has a circumferential collar on its side facing the thrust piece, which is offset from the external thread and whose outer diameter is smaller than the nominal diameter of the external thread, so that in a certain configuration of the ring, the shoulder between the thread and the collar serves as an axial stop for the ring.

In order to counteract the aforementioned diagonal wear of the brake lining, additional measures can be provided in addition to the configuration according to the invention, which cause an offset application of force to the brake lining. Here, too, the configuration of the adjusting spindle according to the invention is supportive, resulting in significantly improved braking behavior overall.

Apart from the aforementioned design of the adjusting spindle, no further modifications are required in principle to achieve the desired goal of reducing diagonal wear and consequently contributing to cost optimization to the desired extent. This means that the manufacture of the new brake plunger is also extremely cost-effective.

Examples of embodiments of the invention are described below with reference to the accompanying drawings.

### BRIEF DESCRIPTION OF THE DRAWINGS

FIG. 1 illustrates a disc brake provided with a brake application device according to the state of the art in a partially sectioned plan view;

FIG. 2 is a side view of a brake plunger of the brake application device according to the state of the art;

FIG. 3 to FIG. 5 are longitudinal sectional views of embodiments of a brake plunger according to the invention.

### DETAILED DESCRIPTION OF THE DRAWINGS

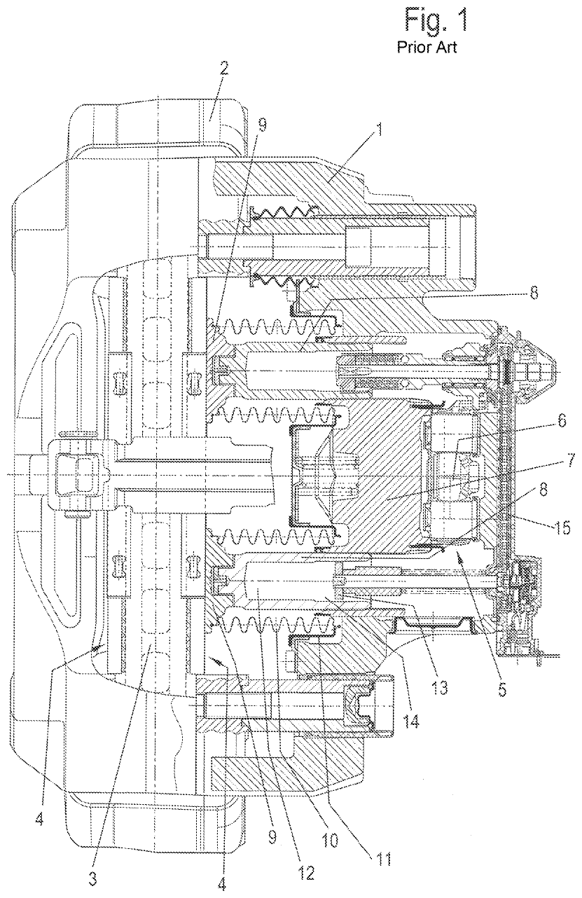

FIG. 1 shows a disc brake according to the state of the art, which has a brake caliper 1 that straddles a brake disc 3 on the vehicle and is held on a fixed brake carrier 2 so as to be axially displaceable in relation to the brake disc 3.

A brake application device 5 is positioned in the brake caliper 1, with a pivoting, pneumatically or electromechanically actuated brake lever 6, which is supported on a bridge 7.

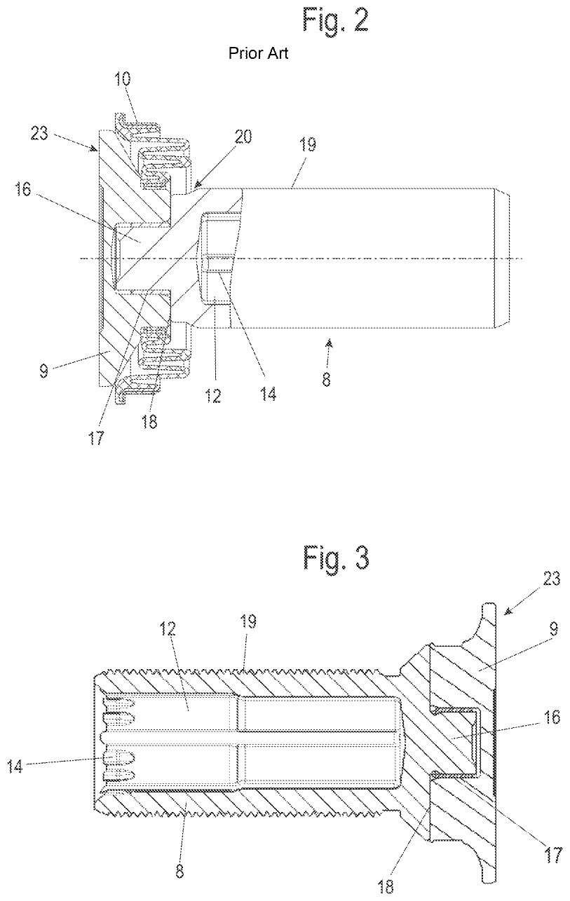

Two brake plungers are screwed into this bridge 7, arranged parallel and at a distance from each other, each of which has an external thread 19 (FIG. 2) that engages in a threaded hole in the bridge 7.

At its end facing away from the brake lever 6, each adjusting spindle 8 has a pressure piece 9 which, in the event of braking, rests with a pressure surface 23 against the action-side brake pad and presses it against the brake disc 3, whereby the reaction-side brake pad 4 is pressed against the opposite side of the brake disc 3 as the braking process continues.

The adjusting spindles 8 pass through a cover 11 that closes a mounting space inside the brake caliper 1, whereby the passage area is sealed by a bellows 10.

In order to compensate for a wear-related change in a clearance, i.e. the distance between the brake pads 4 and the brake disc 3, an adjustment device with a rotating element 13 is provided, which is rotated when the brake lever 6 is actuated and which engages positively in the adjusting spindle 8.

For this purpose, axial grooves 14 are provided in an axial blind bore 12, into which the teeth of the rotating element 13 engage.

A synchronizing device 15, for example in the form of a traction drive, is provided for simultaneous and uniform rotation of the adjusting spindles 8 for the purpose of wear adjustment.

FIG. 2 shows a brake plunger according to the state of the art as a detail. It can be seen that the adjusting spindle 8 has a concentric pin 16 on its end face facing the thrust piece 9, which is adjoined by a radially aligned, annular support surface 18 against which the thrust piece 9 rests. The outer diameter of this supporting surface 18 corresponds to the diameter of a threadless collar 20 and is smaller than the nominal diameter of the external thread 19.

The pin 16 is encased by a sliding ring 17, which allows the adjusting spindle 8 to rotate slightly in relation to the thrust piece 9.

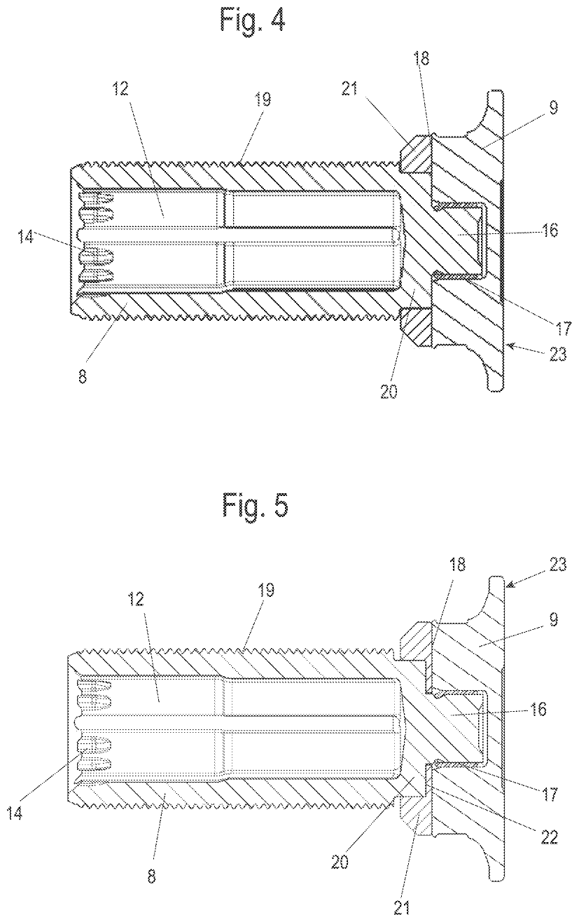

FIGS. 3 to 5 each show an embodiment of a brake plunger according to the invention. What they all have in common is that the outer diameter of the support surface 18 is at least 60% of the diameter of the pressure surface 23 of the pressure piece 9.

A spindle neck of the adjusting spindle is preferably around 20%-40% larger than the diameter of the external thread 19.

In the variant shown in FIG. 3, the end face of the adjusting spindle 8 facing the thrust piece 9 is correspondingly large. In other words, the support surface 18 is an integral part of the adjusting spindle 8.

In the example shown in FIG. 4, the enlarged support surface is formed by fitting a ring 21 onto the collar 20, which is aligned with the end face of the adjusting spindle 8 on the side facing the thrust piece 9 in such a way that the enlarged flat support surface 18 results.

The brake plunger shown in FIG. 5 also has a ring 21, which is pushed onto the collar 20 of the adjusting spindle 8, but which is designed in such a way that the end face facing the thrust piece 9 is covered, so that an uninterrupted support surface 18 is formed. For this purpose, the ring 21 has a flange 22 that is radially aligned towards the pin 16, which flange 22 rests on the end face of the adjusting spindle 8 on the one hand and forms part of the support surface 18 on the other.

A brake application device according to the invention can, in principle, be constructed like the brake application device shown in FIG. 1.

In a preferred embodiment of such a brake application device, it has exactly one brake plunger arranged centrally on the bridge 7, so that instead of the brake application device with two brake plungers shown in FIG. 1, only one central brake plunger presses the action-side brake pad against the brake disc 3 in the event of braking.

### REFERENCE LIST

1 Brake caliper
2 Brake carrier
3 Brake disc
4 Brake pad
5 Brake application device
6 Brake lever
7 Bridge
8 Adjusting spindle
9 Pressure piece
10 Bellows
11 Cap
12 Blind hole
13 Rotating element
14 Axial groove
15 Synchronizing device
16 Pin
17 Slip ring
18 Support surface
19 External thread
20 Collar
21 Ring
22 Flange
23 Pressure surface

1.-8. (canceled)

9. A brake application device of a disc brake for a commercial vehicle, comprising:
a brake lever; and
a brake plunger actuated by the brake lever,
wherein the brake plunger comprises an adjusting spindle provided with an external thread and a pressure piece which bears against a radially aligned support surface of the adjusting spindle that faces a brake pad; and
wherein an outer diameter of the support surface of the adjusting spindle is at least 60% of a diameter of a pressure surface of the pressure piece.

10. The brake application device according to claim 9, wherein the support surface is formed by an end face of the adjusting spindle.

11. The brake application device according to claim 9, further comprising:
a ring arranged on the adjusting spindle on the side facing the pressure piece, which ring forms an aligned support surface with a radially aligned side together with the end face of the adjusting spindle.

12. The brake application device according to claim 9, further comprising:
a ring arranged on the adjusting spindle on the side facing the pressure piece, wherein
the ring has a radially aligned flange which covers an end face of the adjusting spindle facing the thrust piece and forms an uninterrupted support surface.

13. The brake application device according to claim 12, wherein the ring is held on a collar of the adjusting spindle.

14. The brake application device according to claim 11, wherein the ring is held on a collar of the adjusting spindle.

15. The brake application device according to claim 11, wherein the adjusting spindle is rotatable relative to the ring.

16. The brake application device according to claim 12, wherein the adjusting spindle is rotatable relative to the ring.

17. The brake application device according to claim 11, wherein the ring is firmly connected to the adjusting spindle.

18. The brake application device according to claim 12, wherein the ring is firmly connected to the adjusting spindle.

19. The brake application device according to claim 9, wherein
the outer diameter of the supporting surface is 20% to 40% larger than a nominal diameter of the external thread of the adjusting spindle.
